(19) United States
(12) Patent Application Publication
(10) Pub. No.: US 2008/0320397 A1
(43) Pub. Date: Dec. 25, 2008

(54) Integrated sharing of electronic documents

(75) Inventors: Anh Do, Kirkland, WA (US); Martin Gannholm, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/820,467

(22) Filed: Jun. 19, 2007

(51) Int. Cl. G06F 3/00

(52) U.S. Cl. 715/751

(57) ABSTRACT

An online service that allows multiple users to share electronic documents over a computer network. Each user may access the online system after specifying the user's credentials, after which the user may view the user interface specific to that user. The user interface may contain multiple panes, such as a navigation pane and a work pane. The navigation pane may list files owned by the user and may also list files shared with the user by other users. A user may select a file in the navigation pane to view the contents of the file in the work pane. A user may also select a file to share with other users, and the shared file will automatically appear in the other users' interfaces. A user may additionally share a file with a user not registered with the system, and the unregistered user may access the file through a generic interface or may register and then view the file.

### BACKGROUND

With the expanded use of the Internet, computer users are increasingly storing their electronic documents or files on remote computer servers that are geographically remote from the user. Prior to widespread use of computer networks, computer users would generally store their files on a disc, either a hard disc that is internal to the computer or a floppy or external disc that can be separate from the computer.

As networking became more prevalent, computer users were more likely to store files on a server to which the computer could connect over a network. Storing files on a remote server provides users with several benefits. For example, users can store backup copies of their files on a remote server. If the computer crashes or a disaster, such as a flood or a fire occurs, users can recover their data files. Users who store their files on servers may also be able to access their files from multiple locations without having to carry a disc with them. For example, users may be able to access their files from any computer with an Internet connection.

Users who store their files on remote servers may wish to have security procedures to prevent other users from accessing or modifying their files. A user who stores files on a remote computer server may store files containing sensitive information, such as tax returns. To prevent unauthorized access to files, the remote server may assign a username and a password to each user. Each file stored on the server may be associated with a particular username, and for a user to gain access to the file, the user may be required to enter the username and password corresponding to the file.

Conversely, users who store their files on remote computer servers may wish to allow other users to access their files. A first user could allow a second user to access the first user's files by sharing the first user's username and password with the second user. Alternatively, the second user could be given a separate username and password, and the first user could configure the server so that the second user is given access to the first user's files.

### SUMMARY OF INVENTION

An online service operating on a computer network may enhance the ability of multiple users to share artifacts—such as electronic documents created for use with word processing or spreadsheet applications—with each other and to collaborate though accessing those artifacts. The service may incorporate features that simplify sharing of artifacts with one or more other users and facilitate collaboration through simplified access to shared artifacts.

In one aspect, the online service may provide a user interface to the users of the online service. To facilitate operations on shared data, the user interface may present in an integrated fashion a user's own artifacts with other artifacts shared with the first user by other users. In some embodiments, the user interface may comprise multiple panes, whose appearance and functionality could be customized to the user's particular preferences. One pane may present a list of artifacts available to the user, which could include that user's artifacts and also other users' artifacts that have been shared with the user. A second pane may present the contents of a selected artifact and may allow the user to access the artifact. A third pane may present other information related to the artifact such as an editing history, user comments about the artifact, or other metadata.

In another aspect, a first user may share one or more artifacts with a second user. After the first user has shared an artifact with a second user, the service may automatically present the artifact in the list of artifacts in the second user's interface. When the second user accesses the first user's artifact, contents of the artifact may be presented to the second user in the second user's interface in the same manner in which the second user's own artifacts are presented to the second user.

In some embodiments, a first user may choose to share an artifact with a second user, and the second user may not be subscriber of the online service. The second user may be allowed to access the shared artifact via a generic interface, such as a web page. The second user may also choose to become a subscriber of the online service. If the second user does become a subscriber, the shared artifact may appear automatically in the second user's interface without any further action by the first or second user. The shared artifact may appear in connection with other artifacts shared with the second user and with artifacts created by the second user.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a computer network with users accessing and sharing artifacts via an online service;

FIG. 2 is a sketch of a first user's interface presenting the artifacts contained within a workspace;

FIG. 3 is a sketch of a first user's interface presenting the contents of an artifact;

FIG. 4 is a sketch of a first user's interface presenting a panel that allows the first user to share an artifact with other users;

FIG. 5 is a sketch of a second user's interface presenting the workspace shared by the first user with the second user;

FIG. 6 is a sketch of a second user's interface presenting the contents of an artifact shared by the first user with the second user;

FIG. 7 is a sketch of a second user's interface presenting a third panel in the second user's interface where the second user can enter comments about a shared artifact and view comments entered by the first user;

FIG. 8 is a database of information about artifacts stored on a computer-readable medium;

FIG. 9 is a database of information about users stored on a computer-readable medium;

FIG. 10 is a flow chart of a process of a first user accessing a second user's document in the first user's interface;

FIG. 11 is a flow chart of a process of a first user sharing an artifact with a second user and the artifact appearing in the second user's interface; and

FIG. 12 is a flow chart of a process of a first registered user sharing an artifact with a second unregistered user.

### DETAILED DESCRIPTION

The inventors have appreciated that an online service may provide a significantly improved experience for its users by facilitating multiple users to share artifacts and to collaborate in editing and otherwise accessing artifacts. The online service may provide a storage medium, accessible via a computer network, where the users of the online service may store their artifacts. The users of the online service may be registered with the online service and may be required to pay a fee for using the service. Though, payment of a fee for use is not a limitation on the invention. The registered users may be assigned an identifier, such as a username, and may be required to authenticate themselves to the service with, for example, a password.

Each user may have or own multiple artifacts. An artifact may be any unit of electronic information and includes any type of electronic documents or collections of documents. Examples of artifacts include, without limitation, a word processing document, a spreadsheet, an email message, a memo, and a list. Artifacts may also include collections of documents or containers within which documents may be organized. For example a “folder” is an artifact that may contain other artifacts. Additionally, a “workspace” is an artifact that may contain other artifacts.

The online service may provide a user interface to each user that facilitates users accessing and sharing artifacts. After authenticating with the online service, the user may be presented with a user interface customized by or for that user. The user's interface may have multiple panes with different information in each pane. The user may be able to customize the appearance of the user's interface by selecting the number, type, size, and location of the different panes. The user may further be able to select colors or the overall theme of the user's interface.

A user's interface may contain a navigation pane that lists all of the artifacts owned by the user. The ownership of an artifact may be determined by the online service. For example, the creator of an artifact may become the owner. The navigation pane may allow a user to organize all of the artifacts available to the user. For example, the user may be able to group artifacts relating to the same topic within a workspace so that the user can easily find all artifacts relating to that topic.

A user may be able to share the artifacts he owns with other users. The user may be able to control sharing through access control lists so that other users with whom an artifact was shared, called “recipients,” may be able view and/or edit the shared artifact. The user may further be able to control whether the recipients are further able to share the artifact with other users.

When a user shares an artifact with other users, the artifact may then appear in the navigation pane of the recipients' interfaces. Each user's own artifacts and shared artifacts may appear together or may appear in separate locations on the navigation pane.

The inventors have appreciated that presenting artifacts in this fashion improves a user's experience in using the online service for collaboration. When a user chooses to share an artifact with another user, the shared artifact may appear automatically in the recipient's interface. The recipient may thus be relieved from the burden of manually adding the sharing user's artifact to his or her workspace. After the artifact appears in the recipient's workspace, the recipient may be able to choose where he or she would like to place the shared artifact in his or her organizational hierarchy of artifacts, or alternatively, the recipient may choose to delete the artifact from his or her workspace.

Without an online service according to embodiments of the invention, users sharing artifacts would need to make their artifacts available in a public place, such as on a web page. The user would then have notify other users where the artifact is located by providing, for example; an Internet address. Users wanting to access the shared artifact would have to remember or store the location of the shared artifact. A recipient may bookmark the shared artifact or save the location of the artifact in an email message or write it on a piece of paper, or otherwise take some other action to be able to find the artifact later. If users share a large number of artifacts with a large number of users, the situation quickly becomes unwieldy.

In comparison, the online service may automatically add the shared artifact to the recipient's navigation pane, and further, the online service may allow the recipient to organize the shared artifacts to his or her liking. Further, the shared artifact may appear without distractions caused by accessing the artifact in the context in which it is stored. For example, an artifact may be stored in a folder within a directory structure that contains other folders and other artifacts. The other folders and files may be irrelevant to the recipient. Presenting a representation of an artifact in the context of the recipient's interface allows the artifact to be presented without distractions that could be caused by presenting the artifact in the context in which the artifact is stored.

As another example, a recipient may access shared artifacts in association with his or her own artifacts, facilitating use of information shared by other users in completing tasks for which the recipient uses his or her own artifacts. In contrast to prior art systems in which shared artifacts had to be accessed through separate interfaces, based on the location or owner of the artifact, access to shared artifacts may involve 10 fewer windows or other interfaces when the artifacts are integrated into the context of the recipient's interface according to embodiments of the invention. Reducing this complexity may be particularly desirable for a collaborative system in which multiple artifacts may be shared among multiple users.

A user's interface may also have other areas through which the user may access artifacts or perform other functions. By providing an integrated presentation of artifacts, whether shared or owned by a user, the user may more readily perform functions that involve shared artifacts or that integrate shared artifacts with artifacts owned by the user.

For example a user's interface may have a work pane that displays the contents of an artifact, and the user may be able to simultaneously view the navigation pane and the work pane. When a user selects an artifact from the navigation pane, the contents of the artifact may appear in the work pane. The artifacts are thus presented in the context of the user's interface.

How the information contained in an artifact is displayed may depend on the type of an artifact. For example, if the selected artifact is a workspace or a folder, the work pane may display a representation of the artifacts contained within the workspace or folder. This information may be presented in the form of a list, may be presented as icons, or may be presented in any other suitable fashion. If the selected artifact is an office document, such as a word processing document, then the work pane may display the contents of the document in WYSIWYG format.

An online service according to embodiments of the invention may create accounts for users. Creating accounts may allow the online service to identify users so that it may implement access control mechanisms. For example, an aspect of creating an account may be establishing credentials, such as a username and password, that allows the service to securely identify users so that access to shared artifacts is provided only to the intended recipients.

However, in some instances, a first user may desire to share an artifact with a second user who is not registered with the online service and therefore has no account or associated credentials. Accordingly, the online service may support sharing of artifacts with users who have not subscribed to the service and therefore do not have credentials. The first user may indicate the identity of the second user by an email address and the online service may inform the second user that an artifact has been shared with him or her by sending an email to that address. The email received by the second user may contain a message, may contain directions or instructions for accessing the shared artifact, and alternatively or additionally may include a web address with which the second user may be able to access the artifact. The second user may also choose to become a registered user, receiving credentials with which the user can access his or her own user interface. Once the second user registers, then the second user may access the online service using his or her credentials to access an interface and the shared artifact may automatically be listed in the second user's navigation pane without any further action by the first or second user.

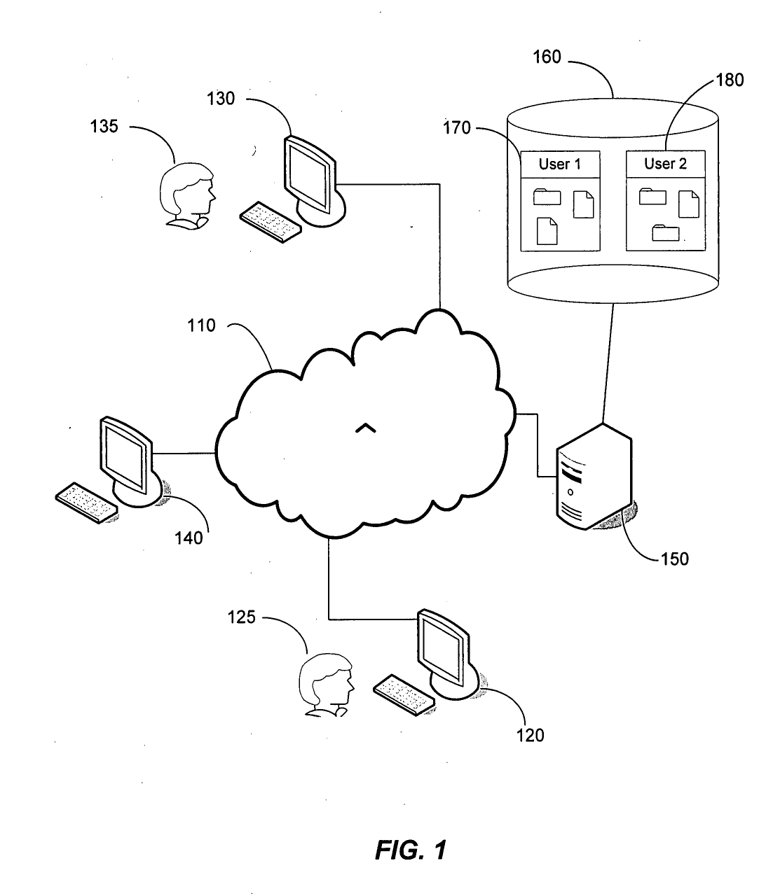

FIG. 1 illustrates users accessing and sharing artifacts using an online service. Online service is hosted on server 150 connected to computer network 110, such as the Internet. Users may access the online service from other computers attached to computer network 110. For example, a first user 125 may use computer 120 to access computer network 110, and a second user 135 may use computer 130 to access computer network 110. Users may not be limited to using a particular computer, and either first user 125 or second user 135 may also be able to use computer 140 to access computer network 110. By using computer network 110, first user 125 and second user 135 may be able to view and edit artifacts stored on server 150.

An online service according to embodiments of the invention may include a database 160 that stores information about users and about artifacts. The information may be organized based on accounts created for users. For example, database 160 may have a first entry 170 that lists artifacts owned by first user 125 and stores information about those artifacts. A second entry 180 may provide similar information about artifacts owned by second user 135. First entry 170 may be created when an account is created for first user 125 and second entry 180 may be created when an account is created for second user 135.

In addition, database 160 may store other information used in the administration of an online service. For example, database 160 may contain information about users who are subscribers to the online service and other information about artifacts, including electronic copies of the artifacts themselves.

FIG. 1 provides a simplified example of an implementation of an online service. The specific components used to implement an online service is not critical to the invention. Server 150 may be any one or more computerized devices that can be accessed by and provide information to other networked computers. Server 150 may be implemented using hardware and software for implementing a web service as is known in the art, but any suitable hardware and/or software may be used. Likewise, database 160 represents organized information stored in a tangible computer-readable medium. The type and location of that media is not critical to the invention.

In operation, first user 125 may access the online service from computer 120 and authenticate herself to online service with credentials, such as a username and password. After authentication, the online service may present the first user's interface, which first user 125 may view on the display of computer 120. To create such an interface, server 150 may render the interface in a format that can be displayed by computer 120. The specific format is not critical to the invention. As one example, computer 120 may be configured with a web browser that displays HTTP pages and server 150 may render the interface as one or more HTTP pages. Using a browser-based interface may allow a user to access artifacts on server 150 from any computer that supports such a browser. However, any suitable format may be used to exchange information between a user computer and the online web service.

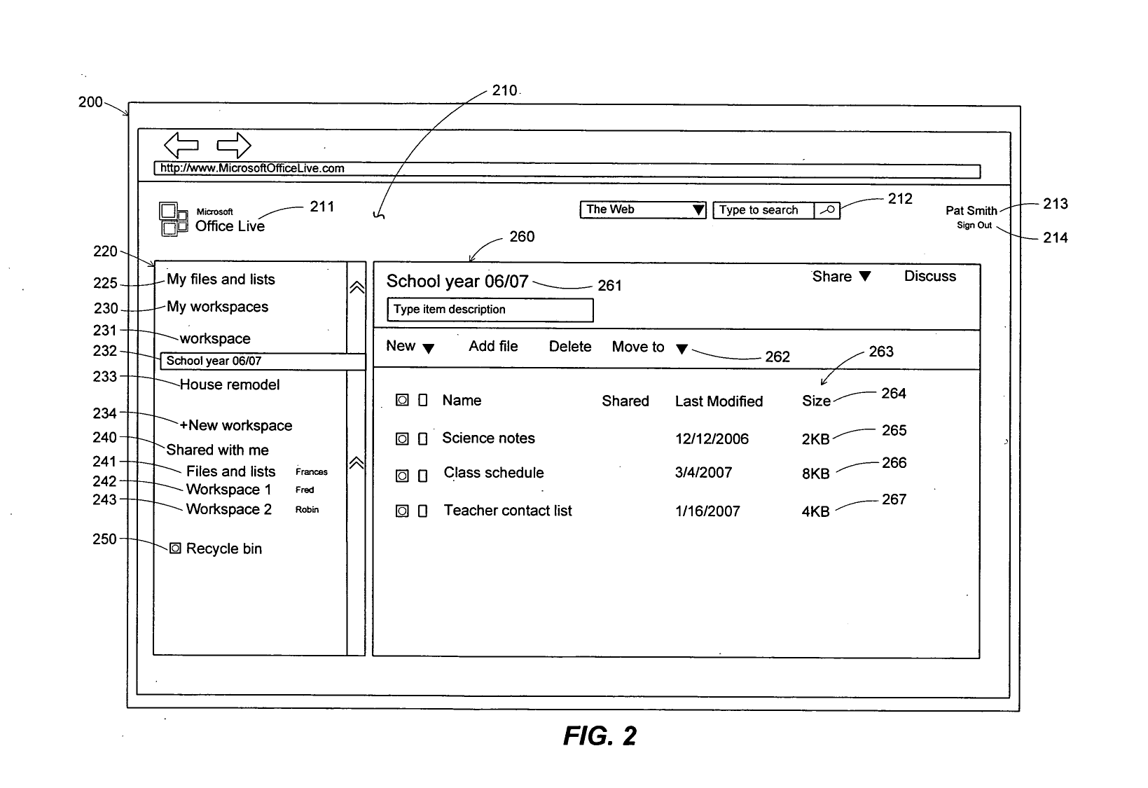

FIG. 2 shows an example of a user interface 200 that may be presented to first user 125. User interface 200 may present one or more types of information to a user and receive one or more types of commands or other information from the user during interactions with the online service. The interface may present information that allows the user to manipulate artifacts and to interact collaboratively. In some embodiments, the interface may be organized into one or more panes, each containing a subset of information presented to the user and command objects accessible by the user.

User interface 200 may contain a header pane 210. Header pane 210 may contain general information about the online service and first user 125. Header pane 210 may contain the logo 211 of the online service. Header pane 210 may also contain a search box 212 that allows users to conduct searches. With search box 212, a user may be able to search the contents of his or her own artifacts, may be able to search the contents of other users' artifacts, or may be able to conduct other searches, such as searches of the Internet. Header pane 210 may also display the name, username, or other information 213 about the first user 125, and may also display an icon or other control 214 that allows the user to cancel the authentication so that subsequent users of the computer will not be able to access the artifacts of the first user 125.

User interface 200 may also contain a navigation pane 220. Navigation pane 220 may present the first user 125 with information about artifacts accessible to her. The manner in which the list of artifacts is presented to a user is not a limiting feature of the invention, and the artifacts may be presented in any suitable manner. Navigation pane 220 may present artifacts owned by first user 125 and may also present artifacts owned by other users which have been shared with first user 125. In FIG. 2, artifacts owned by first user 125 are presented in a list with the title “My files and lists” 225 and a list with the title “My workspaces” 230. Artifacts shared with first user 125 are presented in a separate list with the title “Shared with me” 240. The artifacts contained within list 225, list 230, and list 240 need not be presented separately and may instead be combined into one list or presented in any other suitable manner.

In the embodiment illustrated, the list “My files and lists” 225 does not display any artifacts. The list 225 may be empty or the list 225 may contain artifacts that are not displayed to create more space for list 230 and list 240. If list 225 is not empty, the first user may be able to display the contents of list 225 in navigation pane 220 by selecting list 225 or in any other suitable manner.

The list “My workspaces” 230 presents three artifacts owned by first user 125. The artifacts are named “workspace” 231, “School year 06/07” 232, and “House remodel” 233. In this example, the artifact “School year 06/07” 232 has been selected by first user 125 and is highlighted to indicate that is has been selected. The list “My workspaces” 230 may also present controls that allow first user 125 to create new artifacts, delete artifacts, and perform other operations to facilitate the organization of artifacts. For example, a control “New workspace” 234 may allow first user 125 to create a new artifact and a control “Recycle bin” 250 may allow first user 125 to delete an artifact or remove an artifact from the list.

In the example illustrated, the list “Shared with me” 240 presents artifacts owned by other users that have been shared first user 125. Two shared artifacts are “Workspace 1” 242 and “Workspace 2” 243. The first user 125 may supply the names of these shared artifacts or alternatively the names may be given by the user who has shared them. The “Shared with me” list 240, may also present other information about the shared artifacts, such as the user who has shared the artifact, the permissions given to the user (e.g., permission to view, permission edit, etc.), or any other information about the shared artifact.

User interface 200 may also contain a work pane 260. Work pane 260 may present information about the contents of a selected artifact. How the information in an artifact is displayed may depend on the type of an artifact. For example, if the selected artifact is a “workspace” or a folder, work pane 260 may display a representation of the artifacts contained within the workspace or folder. This information may be presented in the form of a list, may be presented as icons, or may be presented in any other suitable fashion. If the selected artifact is an office document, such as a word processing document, then work pane 260 may display the contents of the document in WYSIWYG format.

In FIG. 2, first user 125 has selected artifact “School year 06/07” 232 in the navigation pane 220, and thus the contents of artifact “School year 06/07” 232 may be presented in work pane 260. Artifact “School year 06/07” 232 is a workspace that contains other artifacts, so work pane 260 may present the artifacts contained within the workspace. For example, as shown in FIG. 2, work pane 260 may present a list 263 of the artifacts contained within the workspace. This list may include information about the contained artifacts, such as name, size, last modification date, and any other useful information. List 263 presents three artifacts contained within artifact “School year 06/07” 232, and the three artifacts are named “Science notes” 265, “Class schedule” 266, and “Teacher contact list” 267. Work pane 260 may also present controls 262 that allow first user 125 to modify the artifact being presented. Controls 262 will vary with the type of artifact being presented. For example, for a workspace artifact, controls 262 may include “New <artifact>,” “Add <artifact>,” “Delete <artifact>,” and any other relevant operation.

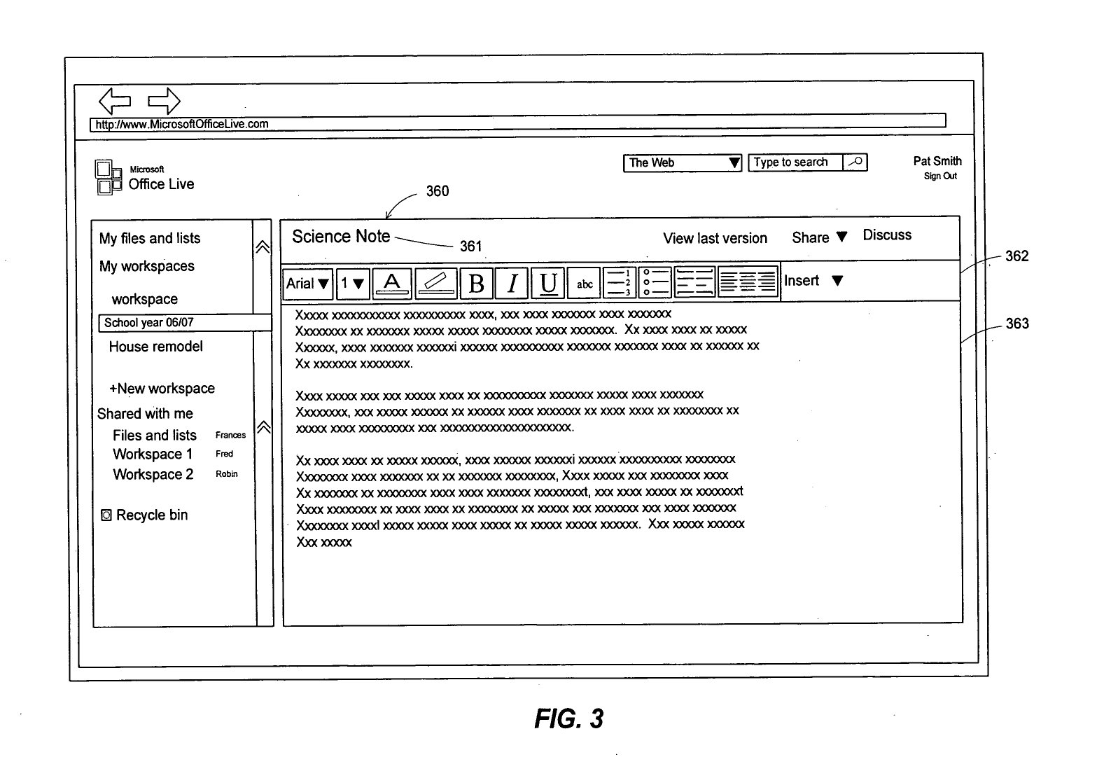

A user may select an artifact from list 263 presented on work pane 260 to view the contents of the artifact. FIG. 3 shows the user interface of FIG. 2 after the user has selected artifact “Science notes” 265 from work pane 260. Work pane 360 may display the title 361 of artifact “Science notes” 265. Artifact “Science notes” 265 is a word processing documents and work pane 360 may present controls 362 appropriate for editing a word processing document. Work pane 360 may also present the contents 363 of artifact “Science notes” 265 in WYSISYG format, and the user may be able edit the contents 363 of the artifact.

After viewing or editing artifact “Science notes” 265, first user 125 may again view the contents of workspace “School year 06/07” 232 as shown in FIG. 2. First user 125 may then choose to share the artifact “School year 06/07” 232 with other users.

The specific mechanism by which a user shares an artifact is not critical to the invention. As one example, user may share an artifact by dragging a representation of an artifact, such as an icon, onto a representation of the user with whom the artifact is to be shared; by entering information about the artifact to be shared and the user with whom the artifact is to be shared into a dialog box; or by any other suitable means.

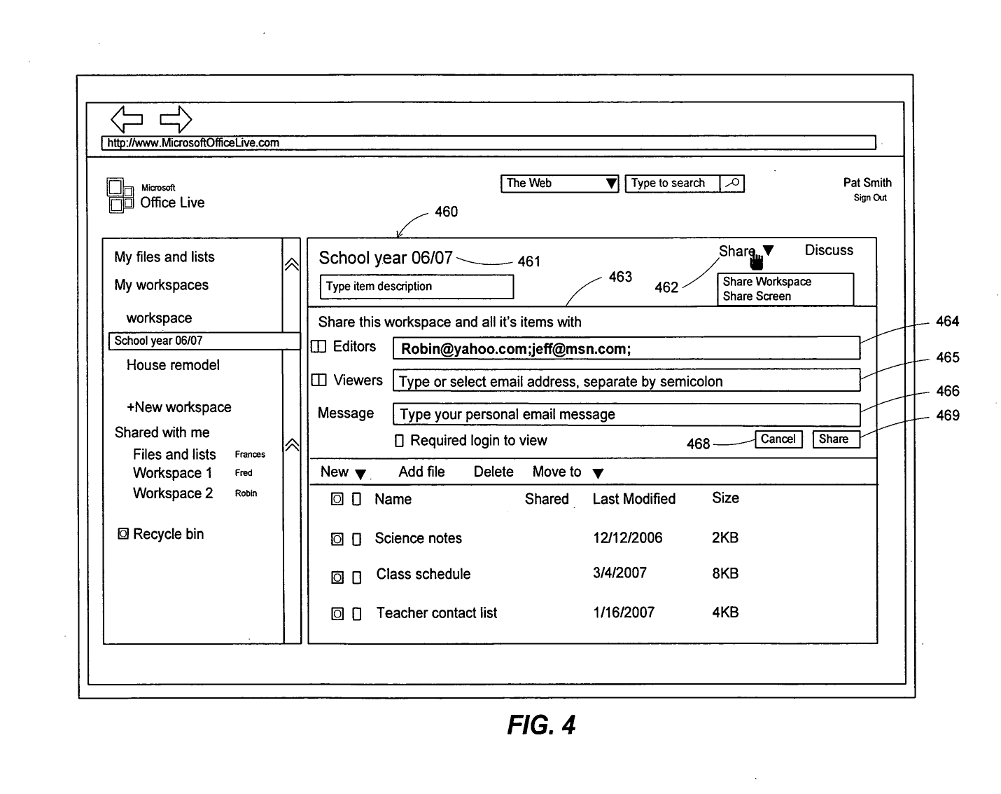

As another example of a command sequence by a user that results in sharing of an artifact, FIG. 4 shows work pane 460 after first user 125 has selected a control 462 to share workspace “School year 06/07” 232 with other users. Work pane 460 presents a group of controls 463 that first user 125 can use to share artifact “School year 06/07” 232 with other users. In control 464, first user 125 may list other users who are to be allowed to edit artifact “School year 06/07” 232. First user 125 may specify the other users via a username, email address, or any other means for identifying the other users. In control 465, first user 125 may similarly list other users who are to be allowed to view artifact “School year 06/07” 232. Another control 466 allows first user 125 to specify a message that is to be sent to the other users with whom artifact “School year 06/07” 232 is being shared. Other controls could also be used to specify how artifact “School year 06/07” 232 is to be shared. For example, sharing users could be allowed to further share the artifact with other users or could be prohibited from doing so. Once first user 125 has completed entering the information about how artifact “School year 06/07” 232 is to be shared, first user 125 may select control 469 to complete the process or may select control 468 to cancel the process. If first user 125 completes the process, a message, such as an email message, may be sent to the users with whom the artifact is being shared, and the artifact may automatically appear in the navigation pane of the other users' interfaces.

In the embodiment illustrated, information input by the user is captured by the online service and used to record information, such as in database 160 (FIG. 1), indicating that a second user is to be given access to the shared artifact. The online service may then use this information to provide access to the shared artifact and to present an appropriate interface to each recipient, including a representation of the shared artifact. In such an embodiment, an e-mail notifying each recipient may be sent by the online service, though the e-mail may be sent by the user who initiated the sharing or from any other suitable source.

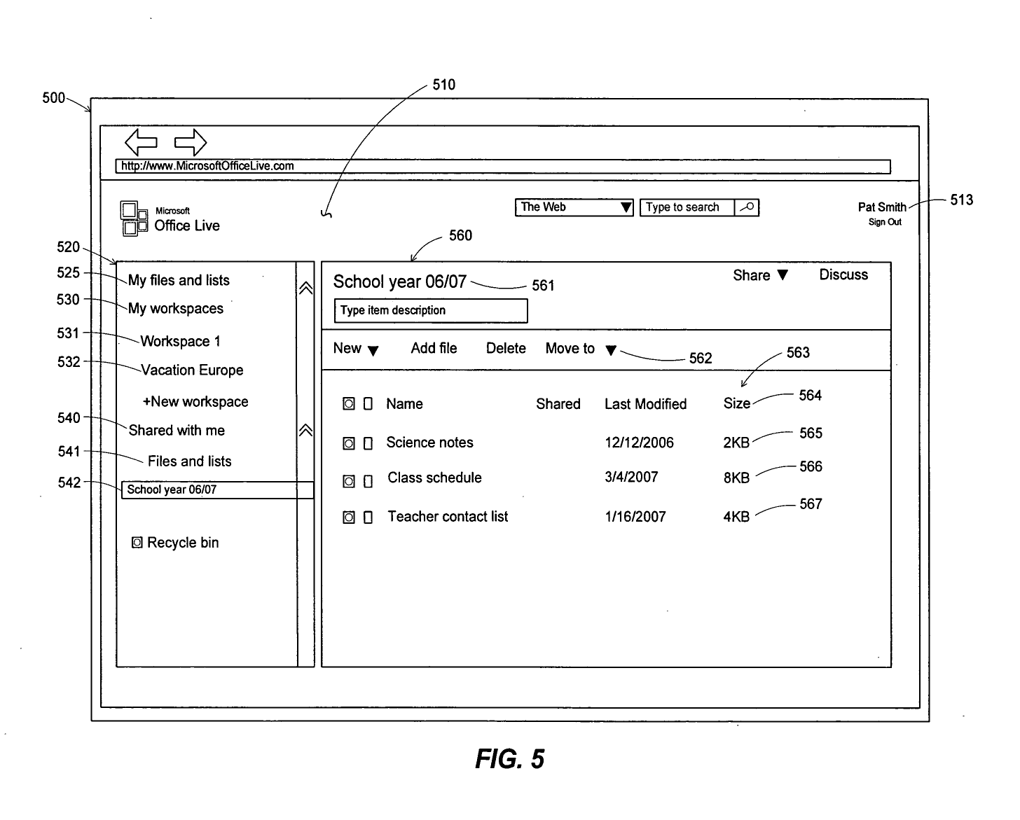

In the example of FIG. 4, first user 125 shared artifact “School year 06/07” 232 with a user having the email address “Robin®yahoo.com.” In this example, this e-mail may be the email address of second user 135. FIG. 5 shows an example of a user interface for second user 135 that may appear when second user 135 accesses her user interface following the sharing of artifact “School year 06/07” 232. Second user's interface may have a header pane 510 that indicates her name or username 513. Her interface may also have a navigation pane 520 that presents artifacts owned by her and artifacts shared with her. As before, the artifacts may be presented in a list “My files and lists” 525, a list “My workspaces” 530, and a list “Shared with me” 540. The online service may automatically render the user interface with a list “Shared with me” 540 including artifact “School year 06/07” 542 without requiring any action by second user 135 to include the shared artifact in her user interface.

Second user's user interface 500 may also have a work pane 560. As described above, second user 135 may view the contents of her artifacts in work pane 560 by selecting one of her artifacts from list “My workspaces” 530. Second user 135 may also view the contents of artifacts shared with her from her “Shared with me” list 540. In the example of FIG. 4, second user 135 has selected artifact “School year 06/07” 542 in her navigation pane 520. The contents of artifact “School year 06/07” 542 are then presented in work pane 560 of second user's interface 500. The sharing of artifact “School year 06/07” 542 is thus integrated into the context of second user's interface 500. Second user 135 may not need to leave the context of her own user interface to view the contents of artifact “School year 06/07” 542, even though artifact “School year 06/07” 542 is owned by first user 125. Second user 135 may view artifacts shared with her in the same manner as her own artifacts.

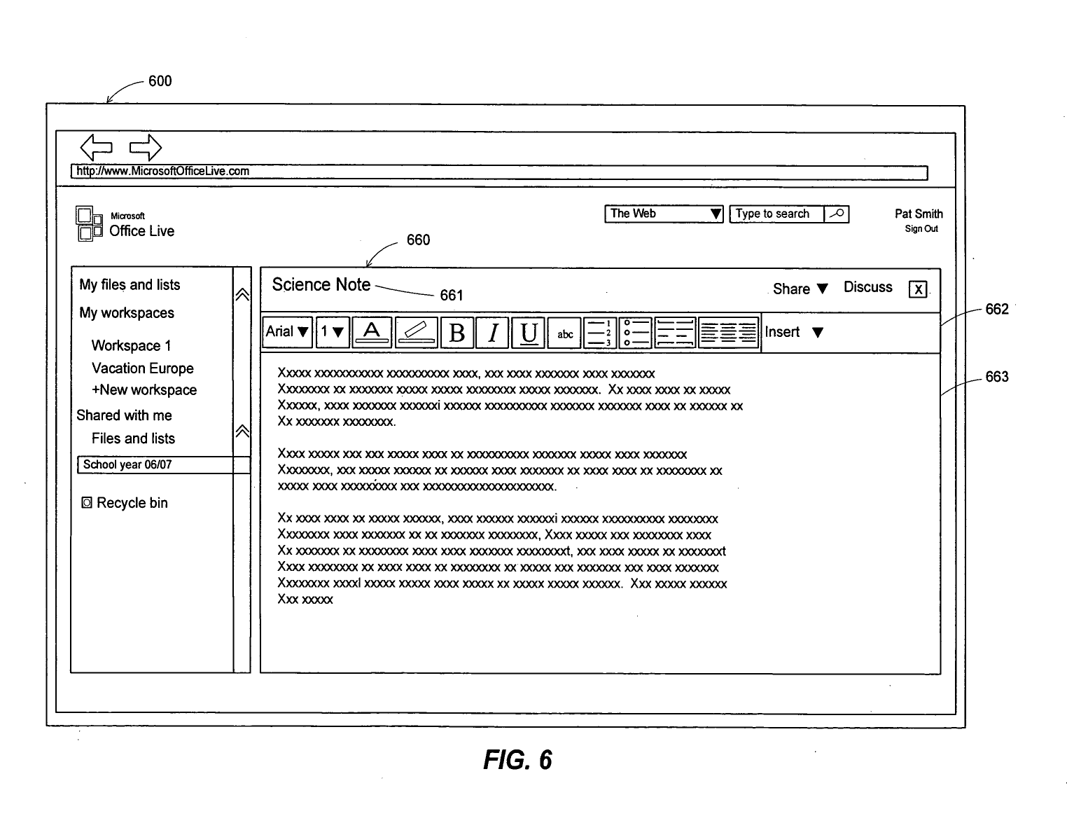

From work pane 560, second user 135 may select artifact “Science notes” 565 in order to view the contents of artifact “Science notes” 565. FIG. 6 shows an example of second user's interface 600, after second user 135 selects artifact “Science notes” 565. The contents of artifact “Science notes” 565 are then presented in work pane 660 of second user's interface 600. As before, the sharing of artifact “Science notes” 565 is integrated into the context of second user's interface 600, and second user 135 does not need to leave the context of her own user interface to view the contents of the artifact.

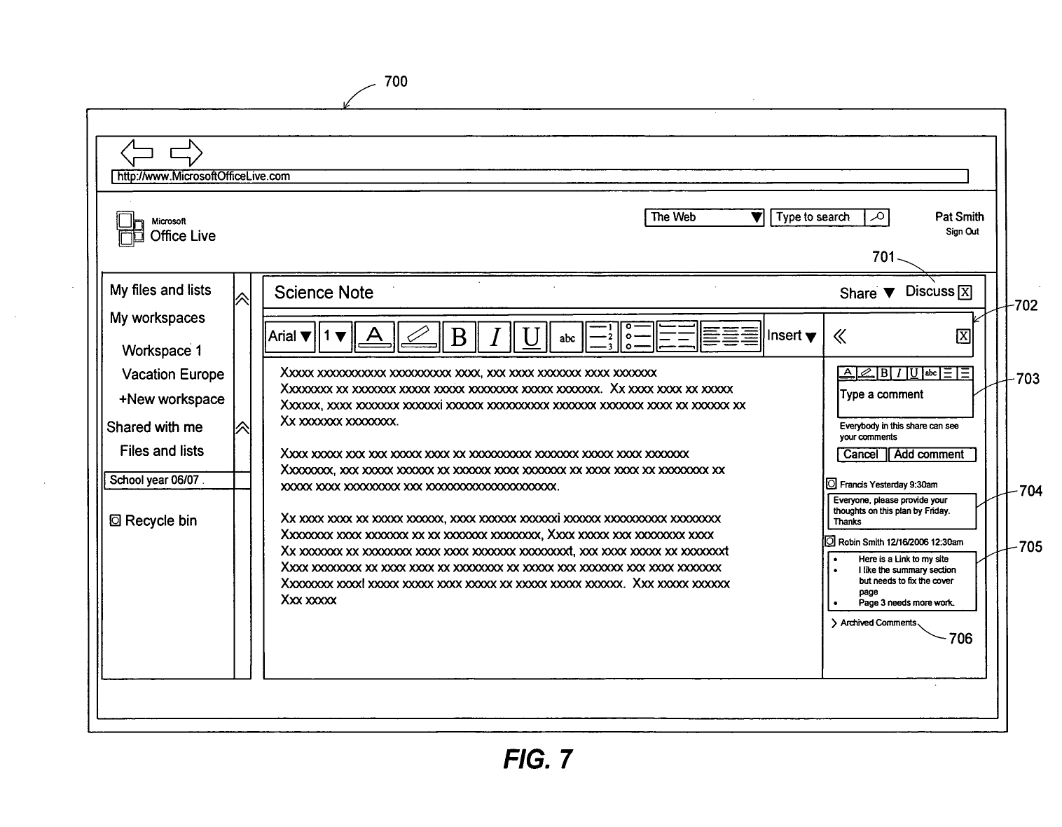

In editing the contents of artifact “Science notes” 565, second user 135 may wish to discuss changes to the artifact with first user 125. The online service may also allow users to discuss artifacts in the context of the user's interface in the form of an online chat. An online chat allows a user to enter to enter a comment and for the comment to automatically and immediately appear on the other users' interfaces. Other users may similarly enter comments for all other users to see. FIG. 7 shows one possible embodiment where second user 135 discusses artifact “Science notes” 565 with other users. From her user interface 700, second user 135 may use control 701 to begin discussing artifact “Science notes” 565. In response to selecting control 701, user interface 700 may present another panel 702 where second user 135 can enter comments and read other users' comments. For example, panel 702 may include a control 703 whereby second user 135 can enter comments about artifact “Science notes” 565. After second user 135 enters a comment, second user's comment may automatically and immediately appear on the user interfaces of other users who are discussing artifact “Science notes” 565. Second user 135 may also view recent comments by other users in panel 702. For example, box 704 shows a comment by a user with a user name “Francis” and box 705 shows a comment by a user with a user name “Robin.” Panel 702 may also include other controls relevant to discussing artifact “Science notes” 565. For example, control 706 may allow a user to view previous comments about artifact “Science notes” 565.

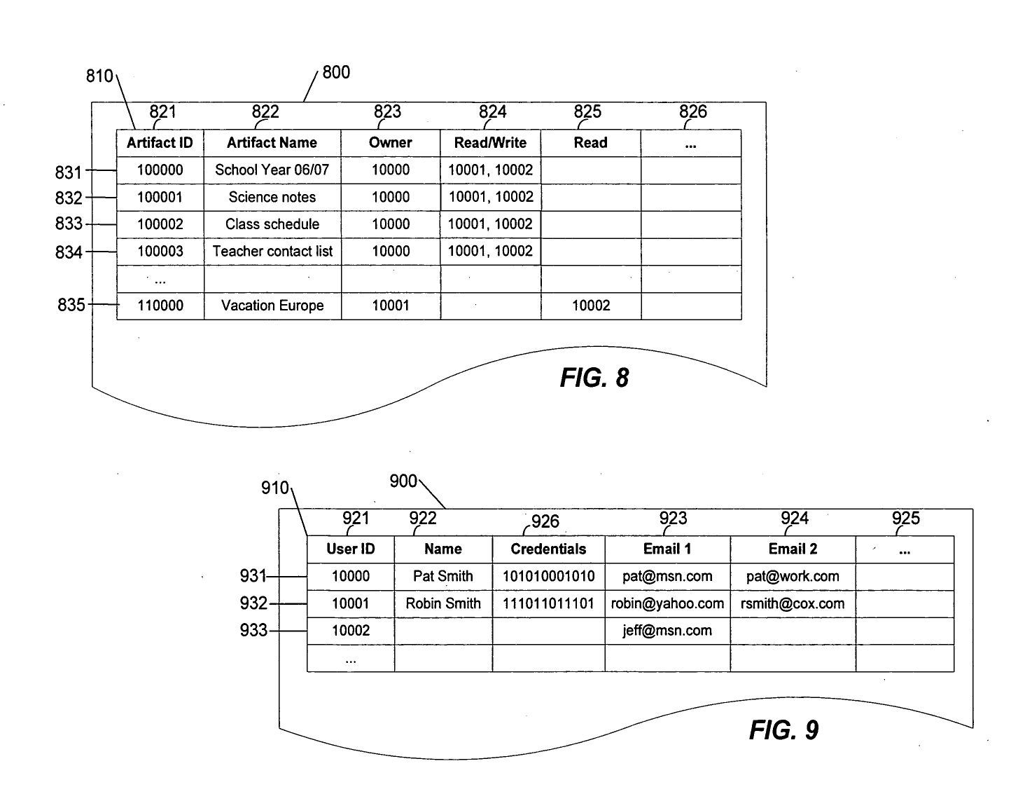

An online service according to embodiments of the invention may store information about users and artifacts in any suitable way. For example, an online service may store information in a database, such as database 160 (FIG. 1) that is stored on a computer-readable medium. FIG. 8 shows an example of a computer-readable medium 800 containing a database 810 storing information about artifacts. Each row of database 810 corresponds to an artifact, and each column of database 810 represents an item of information about an artifact. For example, column 821 may contain an artifact identification number that uniquely identifies each artifact stored on the online service. Though not shown, other information may alternatively or additionally be included to identify the artifact, define its location or otherwise enable an online service to perform operations involving the artifact. Column 822 may contain the name of the artifact as specified by the user creating or owning the artifact.

Information in database 810 may also define one or more users who should be permitted to access the artifact and the level of access each user is to be permitted. For example, column 823 may contain a unique identification number of the user who owns the artifact. The owner of an artifact may be determined by the online service. For example, the user creating an artifact may become the owner of the artifact. Column 824 may contain a list of one or more users who have permission to view and edit the artifact. Column 825 may contain a list of one or more users who have permission to only view the artifact. Other columns may store other information about artifacts as indicated by column 826. Row 831 represents the workspace artifact 232 shown in FIG. 2 and owned by first user 125. First user 125 shared workspace artifact 232 with second user 135, as shown in FIG. 4, and thus the unique identification number of second user 135 appears in column 824. Rows 832, 833, and 834 represent the three artifacts (265, 266, and 267, respectively) contained in workspace artifact 232 as shown in FIG. 2 and also owned by first user 125. Row 835 represents artifact 532 owned by second user 135 as shown in FIG. 5.

In the embodiment illustrated in FIG. 8, users are identified by a unique identification number. The manner in which users are identified and how that identification information is stored or accessed by the service is not critical to the invention. However, in some embodiments, a web service may maintain information about registered users of the service as well as users who are not registered but with whom other users have shared artifacts.

FIG. 9 shows an example of a computer-readable medium 900 containing a database 910 storing information about users. Each row of database 910 corresponds to a user, and each column of database 910 represents an item of information about a user. For example, column 921 may contain a user identification number that uniquely identifies each user of the online service. Column 922 may contain the real name or username of the user. Column 923 may contain a first email address of the user and column 924 may contain a second email address of the user. Other columns may store other information about users as indicated by column 925.

For example, column 926 may store information allowing the service to uniquely identify a user seeking access to the service and/or to validate that a user seeking access to the system is authorized to have that access. The information stored in column 926, for example, may be derived as a hash or other cryptographic function performed on a password assigned to a user. However, the specific mechanism by which the credential information is generated or stored is not a limitation on the invention.

In the example of FIG. 9, the users identified in rows 931 and 932 are shown with credential information. The user identified in row 933 has neither a name or credential information. This information may be omitted in row 933 because the user identified in that row may not be registered with the online service. Nonetheless, the online service may provide to that user access to artifacts that have been shared with that user. If, subsequently, that user does register, the service may associate with that user additional information, such as credential information.

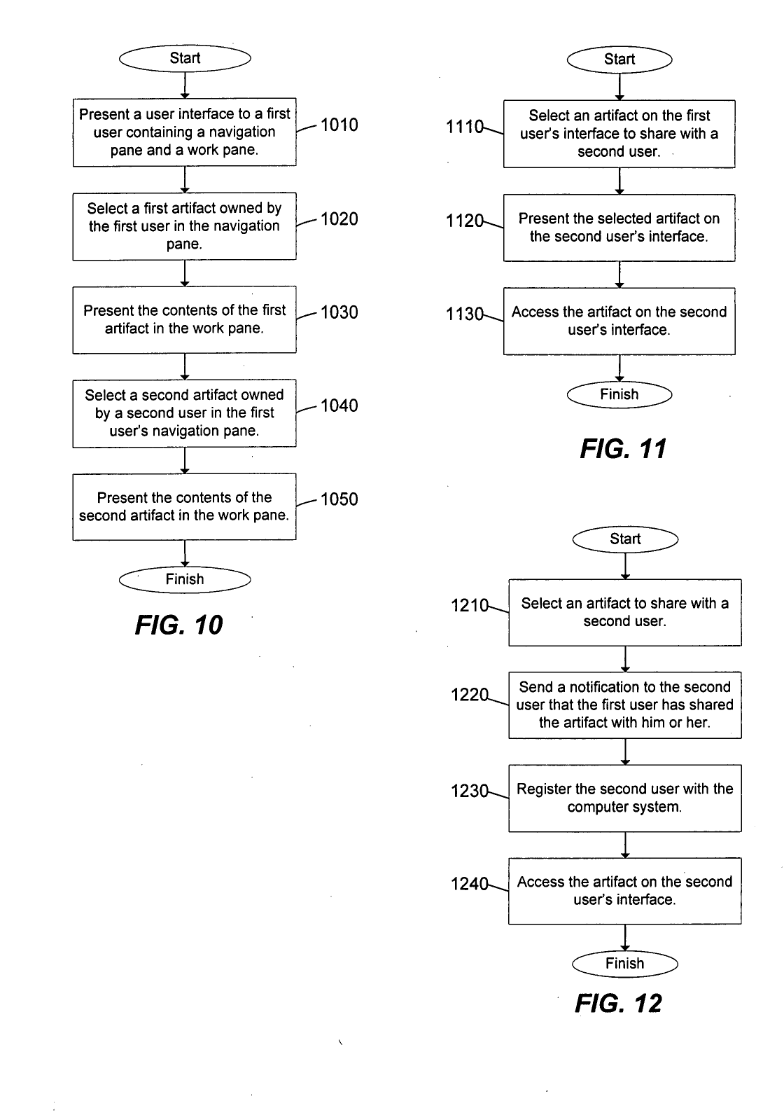

FIG. 10 shows a process whereby the online service presents a user with the contents of artifacts in the context of the user's interface. While FIG. 10 depicts a sequential order of actions, some actions may be carried out in a different order, so the actual order may be different in different embodiments. Therefore, the order of processing is not a limitation on the invention.

At block 1010, the online service presents a user with a user interface containing a navigation pane and a work pane. Examples of interfaces are shown in FIG. 2 and in FIG. 3, but the interface need not have this appearance and any suitable interface may be presented. The navigation pane may present at least one artifact owned by the user and at least one artifact shared with the user by another user. The artifacts may be presented to the user as a list of names, as a list of icons, or by any other suitable presentation.

At block 1020, the user selects an artifact owned by the user. The user may select the artifact by using a mouse to click on the representation of the artifact, by using a keyboard, or by using any other suitable manner to select the artifact. At block 1030, the online service presents the contents of the artifact selected in block 1020 in the work pane. As described above, the manner in which the contents of the artifact are presented may depend on the type of artifact selected. At block 1040, the user selects an artifact shared with the user by another user. The user may be able to select a shared artifact in the same manner as his or her own artifacts. For example, because the shared artifacts are presented in the user's navigation pane, the user may select a shared artifact directly from the user's interface and the shared artifact is thus integrated into the user's interface. At block 1050, the online service presents the contents of the artifact selected in block 1040 in the work pane. The user may thus be able to view the shared artifact in the work pane of the user's interface and need not leave the user's interface to view the shared artifact.

FIG. 11 shows a process whereby a first user of the online service shares an artifact with a second user of the online service. While FIG. 11 depicts a sequential order of actions, some actions may be carried out in a different order, so the actual order may be different in different embodiments. Therefore, the order of processing is not a limitation on the invention.

At block 1110, a first user selects an artifact owned by the first user from the first user's interface to share with a second user. This block may comprise selecting the artifact to be shared, selecting a user to share the artifact with, selecting the level of access the second user will receive, and specifying any other information relevant to sharing an artifact with a second user. For example, the second user may only be allowed to view the shared artifact or may be able to view and edit the shared artifact. FIG. 4 shows one example of an interface allowing the first user to select an artifact to share, indicating the user with whom the artifact will be shared and the level of access the second user will have, but any suitable interface can be used.

At block 1120, the online service may communicate to any computer through which the second user accesses the online service a rendering a user interface that includes the shared artifact. This interface may be communicated in any suitable way. For example, it may be communicated by providing an update to a previously presented interface or may be incorporated in the description of an interface sent to the second user when the second user next accesses the online service. Regardless of how the interface is communicated, the shared artifact may appear automatically in the interface of the second user.

An example of an interface is shown in FIG. 5, where the shared artifact is “School year 06/07” 542, but any suitable interface could be used. If the second user is viewing the second user's interface at the time that the first user shares the artifact with the second user, then the shared artifact may be automatically added to the second user's interface while the second user is viewing it. If the second user is not viewing the second user's interface at the time that the first user shares the artifact with the second user, then the shared artifact may automatically appear in the second user's interface the next time the second user accesses his or her interface. At block 1130, the second user selects the shared artifact to view the contents of the shared artifact in the context of the second user's interface. An example of an interface is shown in FIG. 5, but any suitable interface could be used.

FIG. 12 shows a process whereby a first user, registered with the online service, shares an artifact with a second user, who is not registered with the online service. While FIG. 12 depicts a sequential order of actions, some actions may be carried out in a different order, so the actual order may be different in different embodiments. Therefore, the order of processing is not a limitation on the invention.

At block 1210, a first user, registered with the online service, selects an artifact owned by the first user from the first user's interface to share with a second user, who is not registered with the online service. Block 1210 is similar to block 1110 of FIG. 11 except that in block 1110 the second user is registered with the online service and in block 1210 the second user is not registered with the online service. In block 1110, the first user may be able to identify the second user by an identifying characteristic of the online service, such as an identification number or username. In block 1210, the first user may have to identify the second user with a different identifying characteristic, such as an email address.

At block 1220, the second user is notified that the first user has shared an artifact with the second user. Any appropriate method could be used for notification, such as an email message sent to the second user. The notification may include any relevant information such as the identity of the first user, the artifact being shared, instructions describing how the second user can access the shared artifact, and instructions describing how the second user can register with the online service. The notification may also include a token that uniquely identifies the sharing transaction. The token could be a number, a sequence of characters, or anything else that could be used to uniquely identify the sharing transaction.

In some embodiments, the second user may be able to immediately access the shared artifact. In other embodiments, the second user may be required to register with the online service to access the shared artifact. At block 1230, the second user registers with the online service. Any appropriate manner of registration may be used, as the manner of registration is not a limitation on the invention. In the embodiment illustrated, registration may result in the second user having a user name and credential information.

During registration, the second user may specify information that allows the second user to indicate that the first user has shared an artifact with the second user. For example, the second user could specify a token that was included in the notification sent to the second user. Alternatively, the second user could enter the same identifying characteristic, such as an email address, used by the first user in sharing the artifact with the second user. This information may be input manually by the second user or may be input automatically as a result of the second user accessing a link or otherwise initiating contact with the online service.

The online service may then render a user interface for the second user and automatically include the file shared by the first user in the second user's interface. At block 1240, the second user accesses the second user's interface. The file shared by the first user will automatically appear in the second user's interface. An example of an interface is shown in FIG. 5, where the shared artifact is “School year 06/07” 542, but any suitable interface could be used. The second user may then be able to select the shared artifact and view the contents of the shared artifact in the context of the second user's interface.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for operating a user interface (200) having a navigation pane (220) and a work pane (260), the interface (200) being operated by a first user (125) having an account that gives the first user (125) access to the user interface (200), the method comprising:
presenting (1010) a navigation pane (220) listing a first artifact (232) owned by the first user (125) and listing a second artifact (242) owned by a second user (135) that the second user (135) has shared with the first user (125);
presenting (1030), in response to the first user (125) selecting (1020) the first artifact (232), contents of the first artifact (232) in the work pane (260); and
presenting (1050), in response to the first user (125) selecting (1040) the second artifact (242), contents of the second artifact (242) in the work pane (260).

2. The method of claim 1, wherein the first or second artifact is a workspace (232) and presenting contents of the first or second artifact comprises presenting a list (263) of artifacts contained within the workspace (232).

3. The method of claim 1, wherein the first or second artifact is a word processing document (265) and presenting contents of the first or second artifact comprises presenting the contents (363) of the word processing document in WYSIWYG format.

4. The method of claim 1, wherein the first user has permission to edit the contents of the second artifact in the work pane.

5. The method of claim 1, wherein the navigation pane (220) presents the first artifact (232) and the second artifact (242) in separate lists.

6. The method of claim 1, further comprising presenting, in response to the first user selecting a control (701), a chat pane (702) with which the first user can discuss the first or second artifact with other users.

7. A computer-readable medium encoded with computer-executable instructions that, when executed, perform a method for operating a user computer as part of an online service sharing artifacts among a plurality of users of an online service, the method comprising:
providing (1110) to the online service, in response to input from a user, information identifying at least one artifact (232) from a list (230) of artifacts on a user interface (200), the information (463) identifying an artifact to share with another user;
displaying (1120) at least one shared artifact (542) in the list (540) of artifacts on the user interface (500) in response to information received from the service;
receiving (1020, 1040) input from the user identifying a selected one of the artifacts (232) on the list (230) of artifacts;
communicating the selected artifact (232) to the online service; and
displaying (1030, 1050), in response to information received from the online service, contents of the selected artifact (232), the contents being displayed in the user interface (200).

8. The method of claim 7, wherein displaying contents of the selected artifact (232) further comprises displaying contents of the selected artifact in a work pane (260).

9. The method of claim 8, wherein displaying the list of artifacts (230) further comprises displaying the list of artifacts in a navigation pane (220).

10. The method of claim 9, wherein the work pane (260) and the navigation pane (220) are presented simultaneously.

11. The method of claim 8, wherein the selected artifact is a workspace (232) and displaying the contents of the artifact comprises displaying a list of artifacts contained in the workspace.

12. The method of claim 8, wherein the selected artifact is a word processing document (265) and displaying the contents of the artifact comprises displaying the contents (363) of the word processing document in WYSIWYG format.

13. The method of claim 7, wherein the selected artifact (232) is owned by the user selecting the artifact.

14. The method of claim 7, wherein the selected artifact (232) is not owned by the user selecting the artifact and has been shared with the user selecting the artifact

15. The method of claim 7, wherein the computer executable instructions for displaying contents of the selected artifact comprises a web browser.

16. A computer-readable medium (150) encoded with computer-executable instructions that, when executed, perform a method for sharing artifacts among users of an online service wherein a first user is registered with the online service and a second user is not registered with the online service, the method comprising:
selecting (1210), in response to input (463) from the first user (125), at least one artifact (232) to share with a second user (135);
sending (1220) a notification to the second user (135) that the first user (125) has shared the at least one artifact (232) with the second user (135);
registering (1230) the second user (135) with the online service; and
accessing (1240), in response to input from the second user, the at least one artifact (232) without further input from the first user.

17. The method of claim 16, wherein the second user (135) is notified by an email message.

18. The method of claim 17, wherein the email message includes a link to a web page where the second (135) user can view the contents of the at least one artifact (232) before registering with the online service.

19. The method of claim 16, wherein registering further comprises creating a database entry (933) for the second user (135).

20. The method of claim 19, wherein registering further comprises adding the second user (135) to a list of users who have access to the at least one artifact (232).
